(19) United States
(12) Patent Application Publication
(10) Pub. No.: US 2014/0268861 A1
(43) Pub. Date: Sep. 18, 2014

(54) FIBER LAMP DECORATION

(71) Applicant: CHIN-SHENG YANG, Tainan City (TW)

(72) Inventor: CHIN-SHENG YANG, Tainan City (TW)

(21) Appl. No.: 13/802,754

(22) Filed: Mar. 14, 2013

(51) Int. Cl. G02B 6/44; F21V 21/14

(52) U.S. Cl. CPC G02B 6/4401; F21V 21/14
USPC 362/555; 362/581

(57) ABSTRACT

The present application is related to fiber lamp decoration, mainly comprising a base body, a projecting column and a lampshade. The base body comprises a light-emitting unit and a rotation mechanism inside. The projecting column has hollow patterns and is positioned on the rotation mechanism to be rotated along with the rotation mechanism. The lampshade is light transmissive and fixedly positioned on the base body. The lampshade comprises a plurality of fiber rods. Thereby, as the rotation mechanism in the base body drives the projecting column rotating, light source of the light-emitting unit projects the patterns of the projecting column on the lampshade, and the patterns create dynamical light effect with the rotation of the rotation mechanism, and the light source irradiates the fiber rods to transmit light to increase decoration function.

### (a) TECHNICAL FIELD OF THE INVENTION

The present invention generally relates to a fiber lamp decoration, and more particularly to a lamp decoration design of object visual allocation in an environmental space to create a spectacular visual effect with dynamical light effect and fiber rods.

### (b) DESCRIPTION OF THE PRIOR ART

Generally in daily life, the table ornaments on the desk, such as picture frames, toy decorations and etc, are all artistic, ornamental, static state objects. Therefore, aqua lamps design with paillette, glitter powder or decoration inside presents. By manually putting upside down, manually shaking or flowing the paillette, the glitter powder or the decoration inside by electric power, the visual perception is created thereby. With different objects inside the aqua lamps, the different visual effect can be created. The reaching possibilities, the development of the various visual variations or multifunction, interesting can be provided with. Therefore, the aqua lamps design becomes an issue for the developer of the environment ornaments.

Accordingly, the inventor of the present invention designs and creates a combination of an electronic candle to allow the light source with plenteous visual effects and an aqua lamp with dynamically rotation effect. The artistic, ornamental and interesting conditions can be improved. With constant experiments and improvements, the present invention now can be created.

### SUMMARY OF THE INVENTION

The present invention is related to a fiber lamp decoration, mainly comprising:

a base body, comprising a rotation mechanism inside driven by a power unit and a light-emitting unit located on the rotation mechanism;

a projecting column, being a flexible plate body having hollow patterns, and the projecting column is positioned on the rotation mechanism and circling the light-emitting unit, and the projecting column is rotated along with the rotation mechanism;

a lampshade, being hollow and a light transmissive stereo-configuration fixedly positioned on the base body and comprising a plurality of fiber rods, and the lampshade comprises a through hole, and edge of the through hole forms a turning section, and the fiber rods are embedded at the turning section;

thereby, as the rotation mechanism in the base body drives the projecting column rotating, light source of the light-emitting unit projects the patterns of the projecting column on the lampshade, and the patterns create dynamical light effect with the rotation of the rotation mechanism, and the light source irradiates the fiber rods to transmit light to increase decoration function.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view diagram of the present invention.

FIG. 2 is an exploded view diagram of a base body according to the present invention.

FIG. 3 is an exploded view diagram of a rotation mechanism according to the present invention.

FIG. 4 is a partial sectional diagram of the present invention.

FIG. 5 is a diagram of the light projection of the present invention.

FIG. 6 is a diagram of the working condition of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

First, please refer to FIG. 1 to FIG. 3, which are a perspective diagram, an exploded view diagram and a partial sectional diagram of the fiber lamp decoration according to the present invention. The fiber lamp decoration mainly comprises a base body 1, a projecting column 2 and a lampshade 3.

The base body 1 appears an opening upward. The base body 1 comprises a rotation mechanism 12 inside driven by a power unit 11 and a light-emitting unit 13 located on the rotation mechanism 12. The rotation mechanism 12 comprises a mount 14, a driving gear assembly 15 and a rotary dish 16. In this embodiment, the mount 14 is shaped like a bowl. The mount 14 comprises a plurality of installing shafts 141 extending upward. The driving gear assembly 15 comprises a first gear 151 and a plurality of second gears 152. The first gear 151 and the second gears 152 are rotatably installed on the installing shafts 141. The gears are meshed with one another. The top of the first gear 151 comprises a groove 153. The power unit 11 comprises a rotary shaft 111 extending upward. The rotary shaft 111 comprises a groove 112 corresponding to the groove 153. The groove 153 and the groove 112 are jointed by a belt 17. The rotary dish 16 is socket joint on the mount 14. The rotary dish 16 comprises inner gear teeth 161 to mesh with the driving gear assembly 15.

As shown in FIG. 4, the light-emitting unit 13 comprises a printed circuit board 131 electrically connected to one light-emitting element 132 at least. In this embodiment, a plurality of light-emitting element 132 which located in interval is illustrated. The printed circuit board 131 stands straightly on a circuit board base 133. The circuit board base 133 is fixed on the mount 14 and stretches out of the base body 1. A switch 18 which is connected to a power source for generating power is located at one side of the base body 1. The switch 18 is electrically connected to the printed circuit board 131 for controlling on and off of the light-emitting elements 132. The printed circuit board 131 is capable of controlling light color changes of the light-emitting elements 132. The light-emitting elements 132 can be light emitting diodes.

The projecting column 2 is a flexible plate body having hollow patterns and preferably manufactured by plastic material. The projecting column 2 is positioned on the rotary dish 16 of the rotation mechanism 12 and rotated with the rotary dish 16. The projecting column 2 is circling the light-emitting unit 13. Except the patterns 21 of the projecting column 2 are light transmissive, the other areas are opaque. With the light source of the light-emitting elements 132, the patterns 21 are projected onto the surface of the lampshade 3.

The lampshade 3 is hollow and is a light transmissive stereo-configuration fixedly positioned on the base body 1. The lampshade 3 comprises a plurality of fiber rods 31 disposed outside the lampshade 3. The lampshade 3 comprises a through hole 32. The edge of the through hole 32 forms a turning section 33. The fiber rods 31 are embedded at the turning section 33. The bottom ends of the fiber rods 31 are in accordance with the light-emitting elements 132. Thereby, under the driving state of the power unit 11, the belt 17 drags the driving gear assembly 15 to rotate. The rotary dish 16 is rotated accordingly. Then, the rotary dish 16 drives the projecting column 2 thereon to rotate and the light source of the light-emitting elements 132 project the patterns 21 of the projecting column 2 on the lampshade 3. Because the patterns 21 are rotated along with the rotary dish 16, various dynamical light effects appear. Meanwhile, the light source irradiates the fiber rods 31 to transmit light to increase decoration function. A spectacular visual effect of the lampshade 3 is then created.

Please refer to FIG. 5 and FIG. 6, which are light projection diagrams of the light-emitting elements 132. Because the vertical positions of the light-emitting elements 132 are different, parallax is created when the light source is projecting. Accordingly, the effect of superimposition images is formed to allow the present invention to create multi-level, plenteous visual effects.

With the aforesaid embodiment of the present invention, several benefits are now concluded hereafter:

1. In the fiber lamp decoration of the present invention, the fiber rods stretches out of the lampshade inside out. The light source can irradiate the fiber rods to transmit light to increase decoration function. 2. In the fiber lamp decoration of the present invention, the light-emitting elements and the rotated projecting column are located on the base body, various dynamical light effects appears more. With the position difference of the light, projection and parallax are both created.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A fiber lamp decoration, mainly comprising:
a base body, comprising a rotation mechanism inside driven by a power unit and a light-emitting unit located on the rotation mechanism;
a projecting column, being a flexible plate body having hollow patterns, and the projecting column is positioned on the rotation mechanism and circling the light-emitting unit, and the projecting column is rotated along with the rotation mechanism;
a lampshade, being hollow and a light transmissive stereo-configuration fixedly positioned on the base body and comprising a plurality of fiber rods, and the lampshade comprises a through hole, and edge of the through hole forms a turning section, and the fiber rods are embedded at the turning section;
thereby, as the rotation mechanism in the base body drives the projecting column rotating, light source of the light-emitting unit projects the patterns of the projecting column on the lampshade, and the patterns create dynamical light effect with the rotation of the rotation mechanism, and the light source irradiates the fiber rods to transmit light to increase decoration function.

2. The fiber lamp decoration according to claim 1, wherein said rotation mechanism comprises a mount, a driving gear assembly and a rotary dish, and the mount comprises a plurality of installing shafts, and the driving gear assembly is rotatably installed on the installing shafts to be driven by the power unit, and the rotary dish is socket joint on the mount, and the rotary dish comprises inner gear teeth to mesh with the driving gear assembly.

3. The fiber lamp decoration according to claim 1, wherein said light-emitting unit comprises a circuit board base and a printed circuit board electrically connected to the light-emitting element at least.

4. The fiber lamp decoration according to claim 3, wherein said light-emitting element is a light emitting diode.
